(19) United States
(12) Patent Application Publication
(10) Pub. No.: US 2011/0264816 A1
(43) Pub. Date: Oct. 27, 2011

(54) METHOD FOR ACCESS CONTROL WITHIN A NETWORK AND A NETWORK

(75) Inventor: Mario Lischka, Heidelberg (DE)

(73) Assignee: NEC EUROPE LTD., Heidelberg (DE)

(21) Appl. No.: 13/142,085

(22) PCT Filed: Jan. 11, 2010
(86) PCT No.: PCT/EP10/00086

§ 371 Date: Jun. 24, 2011

(30) Foreign Application Priority Data
Jan. 9, 2009 (EP) 09000215.5

(51) Int. Cl. H04L 29/06

(52) U.S. Cl. 709/229

(57) ABSTRACT

For allowing an effective handling of obligations a method for access control within a network, especially for control of access of a subject to a resource of the network, is disclosed, wherein a PEP (Policy Enforcement Point) sends an access request for evaluation to a PDP (Policy Decision Point) and wherein the PDP sends a reply which contains at least one obligation to the PEP. Whereby for specifying obligations a meta-language as for example OASIS XALML is used.

The present invention relates to a method for access control within a network, especially for control of access of a subject to a resource of the network, wherein a PEP (Policy Enforcement Point) sends an access request for evaluation to a PDP (Policy Decision Point) and wherein the PDP may send a reply which may contain at least one obligation to the PEP. Further, the present invention relates to a network, wherein access control is provided, especially control of access of a subject to a resource of the network, wherein a PEP (Policy Enforcement Point) sends an access request for evaluation to a PDP (Policy Decision Point) and wherein the PDP may send a reply which may contain at least one obligation to the PEP.

During the recent year OASIS (Organization for the Advancement of Structured Information Standards) XACML has become the most recognized standard for the specification of an access control policies language as well as a generic framework for access control. Details of OASIS XACML are obtainable from OASIS eXtensible Access Control Markup Language (XACML) Version 2.0, Final Version, Errata of Jan. 29, 2008. While for access control itself the policy language is flexible enough to cover approaches like Core and Hierarchical Role Based Access Control, the handling of obligation is quit neglected. Although this is quite an important issue especially to support privacy and advanced tracing of data flow. As an example the obligation could enforce the accessing unit to use a certain encryption for data persistency issues, or ensure that a specific action is performed within a given time frame. This is obtainable from Q. Ni, E. Bertino, J. Lobo, An obligation model bridging access control policies and privacy policies, Proceedings of the 13 ACM symposium on Access Control Models and Technologies (SACMAT08), pp 133-142, and from C. Bettini, S. Jajodia, X. Wang, and D. Wijesekera. Obligation monitoring in policy management. In 3rd International Workshop on Policies for Distributed Systems and Networks (POLICY 2002.), IEEE Computer Society.

Although the importance of obligation is recognized there are two major aspects not covered.

First, there is currently no method to specify the obligations exchanged between a policy enforcement point (PEP) and a policy decision point (PDP) in a generic way. Thus, only proprietary and fixed languages are used to express the potential obligations in currently existing solutions. Even in the OASIS XACML standard it is simply assumed that the PEP recognizes the obligations returned by the PDP upon an access request and knows how to implement them correctly. If the PEP does not recognize the obligation, the XACML standard simply assumes that the request is denied. Thus, incompatibilities between PDP and PEP could only be detected at run-time and even then it is unclear if an unknown obligation might occur sometime. This problem is even more severe in a distributed environment, where PDP and PEP are not implemented or controlled by the same organizational entity.

Second, with various policies applicable to a specific request, combination algorithms have to be applied. The handling of the attached obligation is still done in a simple way, as no further examination of the obligation takes place according to the XACML standard, which is obtainable from OASIS eXtensible Access Control Markup Language (XACML) Version 3.0, Working draft 05 of 10 Oct. 2007, sec 7.14. All obligations which have the same—valid—effect and belong to a policy evaluated are returned to the PEP. Conflicts between the obligations are not even considered, thus no detection takes place.

Limiting the set of supported obligations through a standardization body is not a solution for a dynamic and heterogeneous environment. Thus, this would only work for a closed and well-defined application environment.

It is an object of the present invention to improve and further develop a method for access control within a network and an according network for allowing an effective handling of obligations, especially within a distributed environment with independent PDP and PEP.

In accordance with the invention, the aforementioned object is accomplished by a method comprising the features of claim 1 and a network comprising the features of claim 27. According to claim 1 the method is characterized in that for specifying obligations a meta-language is used.

According to claim 27 the network is characterized in that for specifying obligations a meta-language is defined.

According to the invention it has been recognized that it is possible to allow an effective handling of obligations by using a meta-language for specifying said obligations. Such a specification of obligations by a meta-language allows for a suitable definition and description of the respective obligations. Based on such a meta-language the recognition of obligations by a PEP and PDP is possible, even in a distributed environment with independent PDP and PEP, such as in SOA (Service Oriented Architecture) or SaaS (Software as a Service) scenarios. In these kinds of environments distributed evaluation of policies will result into a merged set of obligations whose interrelation can be specified on the basis of the meta-language.

Preferably, the meta-language could be a generic language. Such a generic language could allow for a generic description of obligations even in a distributed environment.

Within a preferred embodiment not only arbitrary obligations can be specified, but also parameters of the obligations. It is further preferred to specify specific data types of the parameters. Thus, a very detailed specification and description of obligations is possible on the basis of the meta-language.

With regard to a very effective handling of obligations a detection and/or specification of possible conflicts between the obligations could be provided on the basis of the specification of the obligations and/or of definitions based on the meta-language. Such a detection and/or specification of possible conflicts between the obligations could be provided in a general way or depending on the assignment of at least one matching value to at least one parameter of each obligation or for two obligations. In other words, such a detection and/or specification could be provided depending on the matching assignment of at least one parameter for two obligations.

Within a further preferred embodiment a negotiation with regard to a respective support of the obligations by PEP and PDP could be provided on the basis of the specification and/or of definitions based on the meta-language. In other words, the present invention can specify a meta-language to specify obligations and potential conflicts between them as well as a method to exchange this specification between the PDP and PEP and negotiate the support of the obligations specified. The description of the supported obligation or obligations and their potential conflicts in a meta-language will be one major aspect of preferred embodiments of this invention.

The present invention describes a method using the specifications based on this language to specify the capabilities of PDP and PEP. Thus, incompatibility between the PEP and PDP could be detected beforehand. The negotiation phase allows the PDP and PEP to request the compatibility of their required and supported obligations, respectively. In case of some mismatches resolution methods could be applied.

As mentioned before, this negotiation process could be repeated at run-time to change the set of obligations used between PDP and PEP. In special cases the negotiation process could be skipped and a direct/manual exchange of the obligation specification could be done. In case this specification is not fully supported by the PEP the deployment has failed. Otherwise, both PDP and PEP could refer to supported obligation specification.

In case of a mismatch with regard to the respective support of the obligations by the PEP and PDP at least one resolution method could be applied. Thus, not only the definition or specification of the obligations and indication of potential conflicts between the specifications but also their resolution is possible.

For providing an effective handling of obligations the specification or specifications of the obligations are negotiated during the deployment of the PEP and PDP. For allowing an adaptation to changing situations the negotiation could be repeated at run-time. During run-time the detection of conflicts between the specifications is also possible.

The negotiation between the PDP and PEP could comprise three types of messages, termed request message, reply message and resolve message. Based on said three types of messages an effective negotiation is possible.

Depending on the individual situation the negotiation could be initiated by the PDP or the PEP. Both cases are possible and could be implemented by an operator.

Within a preferred embodiment the meta-language or specification of obligations could be realized as an extension of or an integration in the XACML standard. Thus, only minor amendments and/or additions to an existing standard are necessary for realizing the present invention.

For providing a very simple specification method an obligation could contain a unique identifier. Preferably, the unique identifier is an URI and a set of parameters whose data types can be specified through URIs. Thus, a very simple handling of obligations is possible.

Within a concrete embodiment an obligation schema and a policy schema could be kept separated. Such a separation will be provided, if the meta-language or specification is realized as an extension of XACML standard.

The combination of an obligation schema and a policy schema is as well possible depending on the individual situation and requirements.

Alternatively, a policy schema could be independent from already existing or previous definitions or schemata, if a dependency from such already existing or previous definitions or schemata is not requested.

Preferably all obligations could be based on a common or agreed or negotiated obligation specification. This would simplify the handling of the obligations.

Such a common obligation specification could be independent from the policy schema, for providing a well-defined and clear structure of components.

Within a preferred embodiment the PEP and/or the PDP could check that a response from the PDP contains only an obligation or obligations used in the common obligation specification. Thus, only negotiated obligations could be used.

For effective handling of obligations a relationship model of the specified obligations could be generated preferably by the PEP and/or the PDP. If a relationship between obligations exists, the possible conflict could be either resolved or escalated for further handling.

Within a concrete embodiment of the inventive method or of the inventive network the PEP and the PDP could be independent from each other. In this context, the PEP and the PDP could be provided in a distributed environment. Within such a distributed environment the present invention is particularly effective with regard to handling of obligations.

For providing a good adaptation to changing situations during network operation the obligation specification and/or definition and/or negotiation could be dynamic.

The present invention is providing a method for specifying arbitrary obligations including their parameters, and potential conflicts between them, either in a general way or depending on the dynamic values assigned, usable to detect incompatibilities during deployment as well as at run-time with additional conflict detection at run-time. Further, conflict detection and resolution based on obligation relations as well as negotiation of supported obligations of the PEP and required obligation of the PDP before regular operation are possible.

The present invention is providing a distributed and independent PEP and PDP implementation with support of arbitrary obligations. Further, detection of obligation incompatibilities between PEP and PDP during deployment and detection of conflicts between combined obligations at run-time are possible.

It is shown, how potential conflicts could be detected during the evaluation of an access request based on the original specification of the obligations.

A meta-language to specify obligations and potential conflicts between them, either in a general way or depending on the dynamic values assigned is provided. The specification of supported obligations of the PEP and required obligations of the PDP is possible. Further possible are a negotiation in case of a mismatch between PDP and PEP of required and supported obligation and a detection of conflicts within combined obligations during the evaluation of a policy request.

There are several ways how to design and further develop the teaching of the present invention in an advantageous way. To this end, it is to be referred to the patent claims subordinate to patent claim 1 on the one hand, and to the following explanation of preferred examples of embodiments of the invention, illustrated by the drawing on the other hand. In connection with the explanation of preferred embodiments of the invention by the aid of the drawing, generally preferred embodiments and further developments of the teaching will be explained. In the drawings

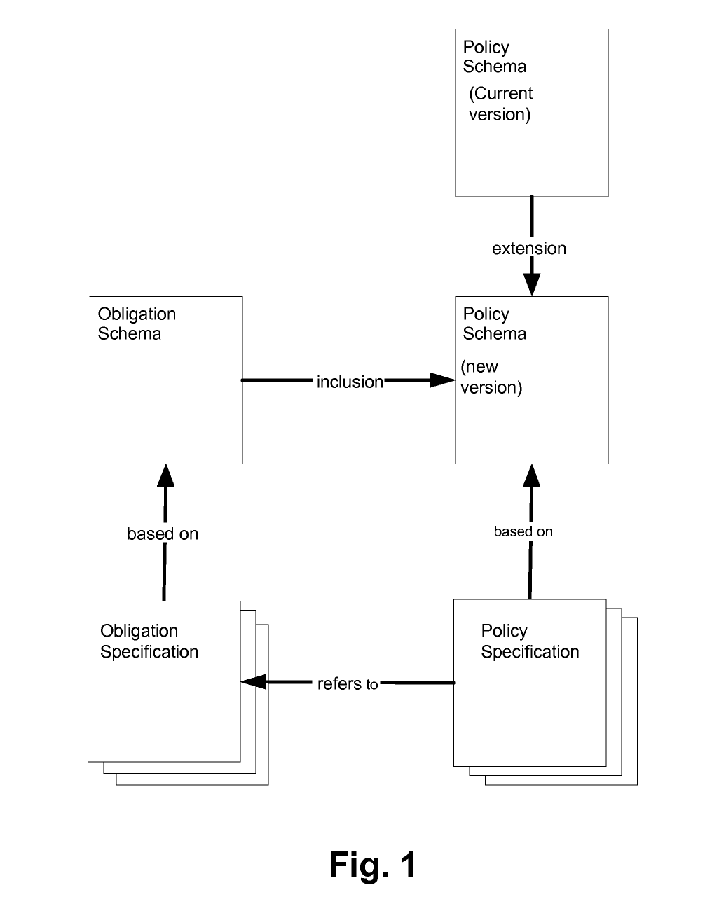

FIG. 1 is illustrating a structure of an extension of an existing standard according to the invention and

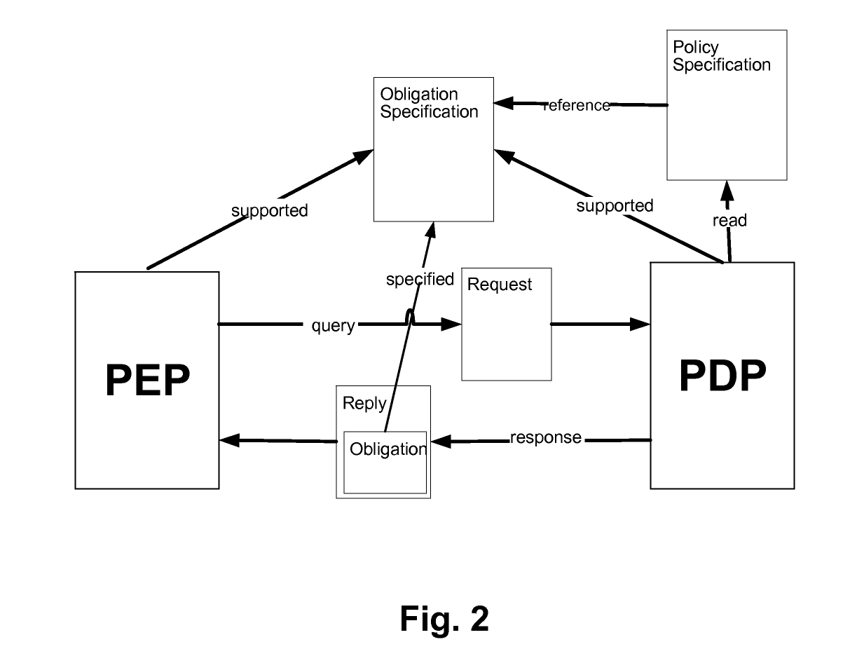

FIG. 2 is illustrating an overview of the usage of the inventive method.

From FIG. 1 is obtainable the structure of an extension of the existing XACML standard. In order to specify the obligations required by a PDP and supported by a PEP a generic meta-language is presented according to the invention.

The concrete obligations used in a PEP and PDP including the related policy could then be specified in a file based on this language specification. In FIG. 1 it is assumed that the related specification is realized as an extension of the existing XACML standard, thus the Obligation Schema and Policy Schema are kept separated. A combined specification is as well possible, also an independent Policy Schema which is not extending any previous definitions. The concrete obligation specification is an independent part, thus any policy specification has to refer to the obligation specification it is using.

Important Aspects of the Embodiment are:

Definition of an Obligation Schema containing
Unique Identifier for each Obligation
Parameter including names and data types
Relations to other obligations
   Independent of current values of the obligation
   Depending on some values of the obligation
   Depending on all values of the obligation p2 Relation between Obligations include conflict, inclusion, contradiction, superordinated, subordinated, and others.
   Extension of the Policy Schema to support references to the obligation specification used by the policies specified.
   Extension of the Messages exchanged between PDP and PEP to include references to the obligation specification.
   The PDP implementation has not to be changed to handle different sets of obligations.

As an embodiment of these aspects an extension of the OASIS XACML, for example 2.0, language is specified as indicated in FIG. 1.

The policy schema is shown as an extension of a current policy schema within FIG. 1. The policy specification is based on the policy schema and is defining the identifier of the respective obligation or obligations which can be processed.

The obligation schema is comprising the structure of defining an obligation. The obligation specification is comprising the type of obligation, e.g. obligation of sending a notification to a given address.

The policy specification is based on the policy schema and refers to the obligation specification. The obligation specification is based on the obligation schema, see FIG. 1.

FIG. 2 is illustrating an overview of an example of usage of the specification of obligations.

During the deployment of the PEP and PDP the obligation specification(s) are negotiated. If a mismatch between the obligations specified by one side and those required or supported by the other side is detected a resolution strategy could be applied as follows:

The negotiation process could be initiated by the PDP or the PEP. The initiator first sends a list with the request obligations. The receiver analyses this list and indicates whether it either supports this obligation or does not support this obligation. For the later case it could indicate a potential solution, either by indicating that the parameter list of an obligation does not match, or the types of a parameter are different on a first glance. If no solutions are available the negotiation could be terminated with a failure.

The initiator could react on proposed solution by either accepting fixed values—including empty ones—for the parameters, or accept a casting of the values to a different type. Additionally, it could withdraw an obligation or ask the other side to ignore it, in case it shows up. Finally, the negotiation process could be terminated with a failure at this point as well.

This negotiation process could be repeated at run-time to change the set of obligations used between PDP and PEP. In special cases the negotiation process could be skipped and direct/manual exchange of the obligation specification could be done. In case this specification is not fully supported by the PEP the deployment has failed. Otherwise both PDP and PEP could refer to supported obligation specification.

The PDP ensures during the loading of policy specification(s) that it only contains those defined in the obligation specification. Independently the PEP could check each access reply whether it contains only those obligation specified. The usage of incompatible obligation specification could be checked based on the supported obligation specification. Independently PEP and PDP could generate a relationship model of all obligation contained in the obligation specification. Various techniques could be used for efficient implementation of this relationship model including but not limited to graphs, linked lists, or hash maps. Based on a conflict a unidirectional relationship—e.g. inclusion—is created and the relevant parameters and the resulting conflicts are given. For a given reply the contained obligation could be checked for a relationship either in the general case or based on the concrete parameter values. If a relationship exists the resulting conflict could be either resolved or escalated for further handling.

Based on the obligation specification both PEP and PDP could independently check that
Reply contains only obligation used in the obligation specification
No incompatible obligations are given in the reply, based on
   General usage of other obligation
   Usage of same data in some parameters
   Usage of same data in all parameters
In case of incompatible obligations further error handling could start
Conflict resolution for obligation relation like inclusion (in case of an inclusion the particular obligation could be considered as fulfilled) and superordinated/subordinated. Through the superordinated/subordinated relationship between obligations the order of the execution is implied and can be resolved by the PEP.

The invention is providing a generic description of obligation, especially within a distributed environment. Required and supported obligations can be exchanged between PDP and PEP to avoid unknown obligations at run-time. It is possible to identify different categories of relations between obligations. Conflicting obligations can be detected in ongoing access requests.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for access control within a network, especially for control of access of a subject to a resource of the network, wherein a PEP (Policy Enforcement Point) sends an access request for evaluation to a PDP (Policy Decision Point) and wherein the PDP may send a reply which may contain at least one obligation to the PEP, characterized in that for specifying obligations a meta-language is used.

2. A method according to claim 1, wherein the meta-language is a generic language.

3. A method according to claim 1, wherein parameters of the obligations are specified.

4. A method according to claim 3, wherein specific data types of the parameters are specified.

5. A method according to claim 1, wherein a detection and/or specification of possible conflicts between the obligations will be provided on the basis of the specification of the obligations and/or of definitions based on the meta-language.

6. A method according to claim 5, wherein detection and/or specification of possible conflicts between the obligations is provided in a general way or depending on the assignment of at least one matching value to at least one parameter of each obligation.

7. A method according to claim 1, wherein a negotiation with regard to a respective support of the obligations by PEP and PDP is provided on the basis of the specification and/or of definitions based on the meta-language.

8. A method according to claim 7, wherein at least one resolution method will be applied in case of a mismatch with regard to the respective support of the obligations.

9. A method according to claim 7, wherein the specification or specifications of the obligations are negotiated during the deployment of the PEP and PDP.

10. A method according to claim 7, wherein the negotiation will be repeated at run-time.

11. A method according to claim 7, wherein the negotiation will be skipped and a direct/manual exchange of the obligation specification will be done.

12. A method according to claim 7, wherein negotiation is comprising three types of messages, request, reply and resolve message.

13. A method according to claim 7, wherein the negotiation will be initiated by the PDP or the PEP.

14. A method according to claim 1, wherein the meta-language or specification of obligations is realized as an extension of or an integration in the XACML standard.

15. A method according to claim 1, wherein an obligation is containing a unique identifier.

16. A method according to claim 15, wherein the unique identifier is an URI and a set of parameters whose data types can be specified through URIs.

17. A method according to claim 1, wherein an obligation schema and a policy schema are kept separated.

18. A method according to claim 1, wherein an obligation schema and a policy schema are combined.

19. A method according to claim 1, wherein a policy schema is independent from already existing or previous definitions or schemata.

20. A method according to claim 1, wherein preferably all obligations are based on a common or agreed or negotiated obligation specification.

21. A method according to claim 20, wherein the obligation specification is independent from the policy schema.

22. A method according to claim 20, wherein the PEP and/or the PDP will check that a response from the PDP contains only an obligation or obligations used in the obligation specification.

23. A method according to claim 1, wherein a relationship model of the specified obligations is generated preferably by the PEP and/or the PDP.

24. A method according to claim 1, wherein the PEP and the PDP are independent from each other.

25. A method according to claim 1, wherein the PEP and the PDP are provided in a distributed environment.

26. A method according to claim 1, wherein obligation specification and/or definition and/or negotiation is dynamic.

27. A network, preferably for carrying out the method according to claim 1, wherein access control is provided, especially control of access of a subject to a resource of the network, wherein a PEP (Policy Enforcement Point) sends an access request for evaluation to a PDP (Policy Decision Point) and wherein the PDP may send a reply which may contain at least one obligation to the PEP, characterized in that for specifying obligations a meta-language is defined.
